(19) United States
(12) Patent Application Publication
(10) Pub. No.: US 2022/0363896 A1
(43) Pub. Date: Nov. 17, 2022

(54) FIBER-REINFORCED, FLAME RETARDANT POLY(ESTER-CARBONATE) COMPOSITIONS

(71) Applicant: SHPP Global Technologies B.V., Bergen op Zoom (NL)

(72) Inventors: Tony Farrell, Bergen op Zoom (NL); Mark Adrianus Johannes Van Der Mee, Bergen op Zoom (NL)

(21) Appl. No.: 17/623,465

(22) PCT Filed: Jun. 19, 2020
(86) PCT No.: PCT/IB2020/055820

§ 371 Date: Dec. 28, 2021

(30) Foreign Application Priority Data
Jun. 28, 2019 (EP) 19183249.2

(51) Int. Cl. C08L 69/00; C08K 13/04; C08G 64/06; B29C 70/02

(52) U.S. Cl. CPC C08L 69/005; C08K 13/04; C08G 64/06; B29C 70/025; C08K 7/14

(57) ABSTRACT

A flame retardant composition includes poly(carbonate-bisphenol phthalate ester) or a combination of poly(carbonate-bisphenol phthalate ester) and a poly(ester), an organophosphorous flame retardant present in an amount effective to provide 0.5-0.8 wt % of added phosphorous; 5-45 wt % of glass fibers; optionally, a poly(carbonate-siloxane); optionally, 0.01-10 wt % of a flame retardant sulfonate salt; optionally, 0.1-0.6 wt % of an anti-drip agent; and optionally, 0.01-10 wt % an additive composition, wherein the amount of the polymer component, the organophosphorous flame retardant, the glass fibers, and the optional components total 100 wt %; and wherein a molded sample of the flame retardant composition has a UL 94 rating of V0 at a thickness of 1.2 millimeter, preferably a CA UL 94 rating of V0 at a thickness 0.8 millimeter.

### CROSS REFERENCE TO RELATED APPLICATIONS

This application claims the benefit of EP Application No. 19183249.2, filed on Jun. 28, 2019, which is incorporated herein by reference in its entirety.

### BACKGROUND

This disclosure relates to poly(ester-carbonate) compositions, and in particular to fiber-reinforced, flame retardant poly(ester-carbonate) compositions, methods of manufacture, and uses thereof.

Polycarbonates are useful in the manufacture of articles and components for a wide range of applications, from automotive parts to electronic appliances. Flame retardant compositions, i.e., polycarbonate compositions comprising fibrous fillers, can provide additional strength and other advantageous properties. Because of their broad use, particularly in electronics, it is desirable to provide flame retardant compositions with improved heat resistance.

There accordingly remains a need in the art for flame retardant compositions having high heat resistance. It would be a further advantage if the compositions had improved flammability ratings at very low thicknesses.

### BRIEF DESCRIPTION

The above-described and other deficiencies of the art are met by a flame retardant composition comprising: a flame retardant composition comprising: 40-94 wt % of a poly(carbonate-bisphenol phthalate ester) comprising aromatic carbonate units and bisphenol phthalate ester units, and optionally, 10-60 wt %, preferably 10-50 wt % of a poly(carbonate-siloxane); 1-15 wt % of an organophosphorous flame retardant, present in an amount effective to provide 0.5-0.8 wt % of added phosphorous; 5-45 wt % of glass fibers; optionally, 0.01-10 wt % of a flame retardant sulfonate salt; optionally, 0.1-0.6 wt % of an anti-drip agent; and optionally, 0.01-10 wt %, preferably 0.01-5 wt % of an additive composition, wherein the amount of the poly(carbonate-bisphenol phthalate ester), the organophosphorous flame retardant, the glass fibers, and the optional components total 100 wt %; wherein a molded sample of the flame retardant composition has a UL 94 rating of V0 at a thickness of 1.2 millimeter, preferably a UL 94 rating of V0 at a thickness 0.8 millimeter.

In another aspect, a flame retardant composition comprises: 30-89 wt % of a poly(carbonate-bisphenol phthalate ester) comprising aromatic carbonate units and bisphenol phthalate ester units, 5-25 wt % of a poly(ester), and optionally, 5-25 wt %, preferably 5-20 wt % of a poly(carbonate-siloxane); 1-15 wt % of an organophosphorous flame retardant, present in an amount effective to provide 0.5-0.8 wt % of added phosphorous; 5-45 wt % of glass fibers; optionally, 0.01-10 wt % of a flame retardant sulfonate salt; optionally, 0.1-0.6 wt % of an anti-drip agent; and optionally, 0.01-10 wt %, preferably 0.01-5 wt % of an additive composition, wherein the amount of the poly(carbonate-bisphenol phthalate ester), the poly(ester), the organophosphorous flame retardant, the glass fibers, and the optional components total 100 wt %; wherein a molded sample of the flame retardant composition has a UL 94 rating of V0 at a thickness of 1.2 millimeter, preferably a UL 94 rating of V0 at a thickness 0.8 millimeter.

In another aspect, a method of manufacture comprises combining the above-described components to form a flame retardant composition.

In yet another aspect, an article comprises the above-described flame retardant composition.

In still another aspect, a method of manufacture of an article comprises molding, extruding, or shaping the above-described flame retardant composition into an article.

The above described and other features are exemplified by the following detailed description, examples, and claims.

### DETAILED DESCRIPTION

There is a need for thin-walled articles made from reinforced, flame retardant polycarbonate compositions having high heat resistance, while maintaining other properties such as impact and relative temperature index (RTI). In particular, compositions for thin-walled compositions are needed having a heat deformation temperature (HDT) of greater than 115° C. and a UL-94 flammability rating of V1, preferably V0, at 0.8 millimeter (mm). In addition, there is an increasing demand for more environmentally friendly polycarbonate compositions without bromine and chlorine. Some commercially available chlorine-free and bromine-free polycarbonate compositions that include flame retardants such as Rimar salt or poly(tetrafluoroethylene) have good heat resistance and impact properties; but do not possess adequate flammability ratings at low thicknesses, less than 1 millimeter (mm), for example. Other commercially available polycarbonate compositions that include chlorine-free and bromine-free flame retardants possess good flammability ratings at low thicknesses, but these materials have insufficient heat resistance for some high heat applications. For example, it is known that phosphonate or phosphazene flame retardants can decrease the heat resistance of polycarbonate compositions.

Surprisingly and unexpectedly, the inventors hereof have discovered reinforced, flame retardant polycarbonate compositions having high heat resistance, flammability ratings of V1, preferably V0, at a thickness of 1.2 mm or 0.8 mm, and good impact properties. These compositions comprise a poly(carbonate-bisphenol phthalate ester) or a combination of a poly(carbonate-bisphenol phthalate ester) and a poly(ester), and optionally, a poly(carbonate-siloxane); an aromatic organophosphorous flame retardant present in an amount effective to provide 0.5-0.8 wt % of added phosphorous; and 5-45 wt % of glass fibers, wherein each amount is based on the total weight of the flame retardant composition, which sums to 100 wt %.

The poly(carbonate-bisphenol phthalate ester) and the optional poly(carbonate-siloxane) of the flame retardant compositions each include aromatic carbonate units of formula (1)

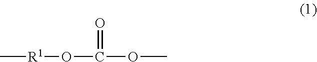

in which at least 60 percent of the total number of R¹ groups contain aromatic moieties and the balance thereof are aliphatic, alicyclic, or aromatic. In an aspect, each R¹ is a C₆₋₃₀ aromatic group, that is, contains at least one aromatic moiety. R¹ can be derived from an aromatic dihydroxy compound of the formula HO—R¹—OH, in particular of formula (2)

HO-A¹-Y¹-A²-OH (2)

wherein each of A¹ and A² is a monocyclic divalent aromatic group and Y¹ is a single bond or a bridging group having one or more atoms that separate A¹ from A². In an aspect, one atom separates A¹ from A². Preferably, each R¹ can be derived from a bisphenol of formula (3)

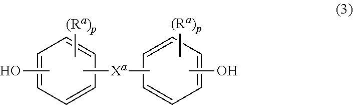

wherein R^{a} and R^{b} are each independently a halogen, C₁₋₁₂ alkoxy, or C₁₋₁₂ alkyl, and p and q are each independently integers of 0-4. It will be understood that when p or q is less than 4, the valence of each carbon of the ring is filled by hydrogen. Also in formula (3), X^{a} is abridging group connecting the two hydroxy-substituted aromatic groups, where the bridging group and the hydroxy substituent of each C₆ arylene group are disposed ortho, meta, or para (preferably para) to each other on the C₆ arylene group. In an aspect, the bridging group X^{a} is single bond, —O—, —S—, —S(O)—, —S(O)₂—, —C(O)—, or a C₁₋₆₀ organic group. The organic bridging group can be cyclic or acyclic, aromatic or non-aromatic, and can further comprise heteroatoms such as halogens, oxygen, nitrogen, sulfur, silicon, or phosphorous. The 1-60 organic group can be disposed such that the C₆ arylene groups connected thereto are each connected to a common alkylidene carbon or to different carbons of the C₁₋₆₀ organic bridging group. In an aspect, p and q is each 1, and R^{a} and R^{b} are each a C₁₋₃ alkyl group, preferably methyl, disposed meta to the hydroxy group on each arylene group.

In an aspect, X^{a} is a C₃₋₁₈ cycloalkylidene, a C₁₋₂₅ alkylidene of formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{c})— wherein R^{c} is a divalent C₁₋₁₂ hydrocarbon group. Groups of these types include methylene, cyclohexylmethylidene, ethylidene, neopentylidene, and isopropylidene, as well as 2-[2.2.1]-bicycloheptylidene, cyclohexylidene, 3,3-dimethyl-5-methylcyclohexylidene, cyclopentylidene, cyclododecylidene, and adamantylidene.

In another aspect, X^{a} is a C₁₋₁₈ alkylene, a C₃₋₁₈ cycloalkylene, a fused C₆₋₁₈ cycloalkylene, or a group of the formula -J¹-G-J²- wherein J¹ and J² are the same or different C₁₋₆ alkylene and G is a C₃₋₁₂ cycloalkylidene or a C₆₋₁₆ arylene.

For example, X^{a} can be a substituted C₃₋₁₈ cycloalkylidene of formula (4)

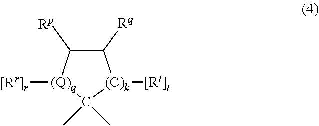

wherein R^{r}, R^{p}, R^{q}, and R^{t} are each independently hydrogen, halogen, oxygen, or C₁₋₁₂ hydrocarbon groups; Q is a direct bond, a carbon, or a divalent oxygen, sulfur, or —N(Z)— where Z is hydrogen, halogen, hydroxy, C₁₋₁₂ alkyl, C₁₋₁₂ alkoxy, C₆₋₁₂ aryl, or C₁₋₁₂ acyl; r is 0-2, t is 1 or 2, q is 0 or 1, and k is 0-3, with the proviso that at least two of R^{r}, R^{p}, R^{q}, and R^{t} taken together are a fused cycloaliphatic, aromatic, or heteroaromatic ring. It will be understood that where the fused ring is aromatic, the ring as shown in formula (4) will have an unsaturated carbon-carbon linkage where the ring is fused. When k is one and q is 0, the ring as shown in formula (4) contains 4 carbon atoms, when k is 2, the ring as shown in formula (4) contains 5 carbon atoms, and when k is 3, the ring contains 6 carbon atoms. In an aspect, two adjacent groups (e.g., R^{q} and R^{t} taken together) form an aromatic group, and in another aspect, R^{q} and R^{t} taken together form one aromatic group and R^{r} and R^{p} taken together form a second aromatic group. When R^{q} and R^{t} taken together form an aromatic group, R^{p} can be a double-bonded oxygen atom, i.e., a ketone, or Q can be —N(Z)— wherein Z is phenyl.

Bisphenols wherein X^{a} is a cycloalkylidene of formula (4) can be used in the manufacture of polycarbonates containing phthalimidine carbonate units of formula (1a)

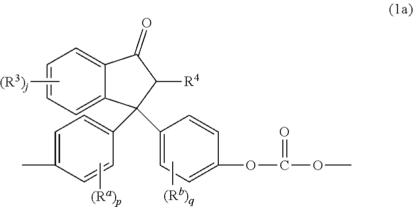

wherein R^{a}, R^{b}, p, and q are as in formula (3), R³ is each independently a C₁₋₆ alkyl, j is 0-4, and R₄ is hydrogen, C₁₋₆ alkyl, or a substituted or unsubstituted phenyl, for example a phenyl substituted with up to five C₁₋₆ alkyls. For example, the phthalimidine carbonate units are of formula (1b)

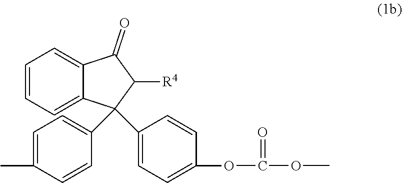

wherein R⁵ is hydrogen, phenyl optionally substituted with up to five 5 C₁₋₆ alkyls, or C₁₋₄ alkyl. In an aspect in formula (1b), R⁵ is hydrogen, methyl, or phenyl, preferably phenyl. Carbonate units (1b) wherein R⁵ is phenyl can be derived from 2-phenyl-3,3′-bis(4-hydroxy phenyl)phthalimidine (also known as 3,3-bis(4-hydroxyphenyl)-2-phenylisoindolin-1-one, or N-phenyl phenolphthalein bisphenol (“PPPBP”)).

Other bisphenol carbonate repeating units of this type are the isatin carbonate units of formula (1c) and (1d)

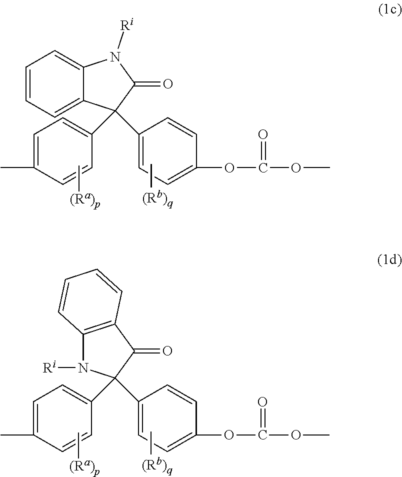

wherein R^{a} and R^{b} are each independently a halogen, C₁₋₁₂ alkoxy, or C₁₋₁₂ alkyl, p and q are each independently 0-4, and Rⁱ is C₁₋₁₂ alkyl, phenyl optionally substituted with 1-5 C₁₋₁₀ alkyl, or benzyl optionally substituted with 1-5 C₁₋₁₀ alkyl. In an aspect, R^{a} and R^{b} are each methyl, p and q are each independently 0 or 1, and R¹ is C₁₋₄ alkyl or phenyl.

Other examples of bisphenol carbonate units derived from of bisphenols (3) wherein X^{a} is a substituted or unsubstituted C₃₋₁₈ is cycloalkylidene include the cyclohexylidene-bridged bisphenol of formula (1e)

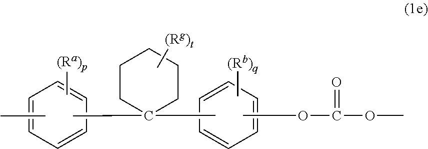

wherein R^{a} and R^{b} are each independently C₁₋₁₂ alkyl, R^{g} is C₁₋₁₂ alkyl, p and q are each independently 0-4, and t is 0-10. In a specific aspect, at least one of each of R^{a} and R^{b} are disposed meta to the cyclohexylidene bridging group. In an aspect, R^{a} and R^{b} are each independently C₁₋₄ alkyl, R^{g} is C₁₋₄ alkyl, p and q are each 0 or 1, and t is 0-5. In another specific aspect, R^{a}, R^{b}, and R^{g} are each methyl, p and q are each 0 or 1, and t is 0 or 3, preferably 0. In still another aspect, p and q are each 0, each R^{g} is methyl, and t is 3, such that X^{a} is 3,3-dimethyl-5-methyl cyclohexylidene.

Examples of other bisphenol carbonate units derived from bisphenol (3) wherein X^{a} is a substituted or unsubstituted C₃₋₁₈ cycloalkylidene include adamantyl units of formula (1f) and fluorenyl units of formula (1g)

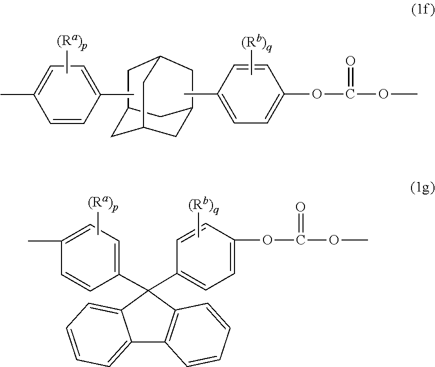

wherein R^{a} and R^{b} are each independently C₁₋₁₂ alkyl, and p an q are each independently 1-4. In a specific aspect, at least one of each of R^{a} and R^{b} are disposed meta to the cycloalkylidene bridging group. In an aspect, R^{a} and R^{b} are each independently C₁₋₃ alkyl, and p and q are each 0 or 1; preferably, R^{a}, R^{b} are each methyl, p and q are each 0 or 1, and when p and q are 1, the methyl group is disposed meta to the cycloalkylidene bridging group. Carbonates containing units (1a) to (1g) are useful for making polycarbonates with high glass transition temperatures (Tg) and high heat distortion temperatures.

Other useful dihydroxy compounds of the formula HO—R¹—OH include aromatic dihydroxy compounds of formula (5)

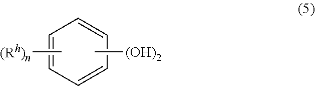

wherein each R^{h} is independently a halogen atom, C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0-4. The halogen is usually bromine.

Some illustrative examples of specific dihydroxy compounds are described, for example, in WO 2013/175448 A1, US 2014/0295363, and WO 2014/072923. Specific examples of bisphenol compounds of formula (3) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-2-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). A combination can also be used. In a specific aspect, the polycarbonate is a linear homopolymer derived from bisphenol A, in which each of A¹ and A² is p-phenylene and Y¹ is isopropylidene in formula (3).

The poly(carbonate-bisphenol phthalate ester)s further contain, in addition to recurring carbonate units of formula (1), repeating units of formula (5)

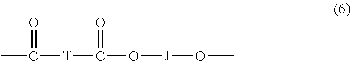

wherein J is a divalent group derived from a bisphenol of formula (3) (including a reactive derivative thereof); and T is a divalent group derived from a isophthalic or terephthalic acid. A combination of isophthalic acid and terephthalic acid can be used, wherein the weight ratio of isophthalic acid to terephthalic acid is 91:9-2:98. The molar ratio of ester units to carbonate units in the copolymers can vary broadly, for example from 1:99-99:1, preferably from 10:90-90:10, or from 25:75-75:25, or from 2:98-15:85, depending on the desired properties of the final composition.

In a specific aspect, the poly(carbonate-bisphenol phthalate ester) is a poly(bisphenol A carbonate)-co-(bisphenol A-phthalate-ester) of formula (7a)

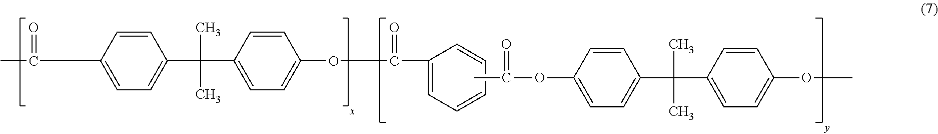

wherein y and x represent the wt % of bisphenol phthalate ester units and bisphenol A carbonate units, respectively. Generally, the units are present as blocks. In an aspect, the wt % of ester units y to carbonate units x in the copolymers is 50:50-99:1, or 55:45-90:10, or 75:25-95:5. Copolymers of formula (7a) comprising 35-45 wt % of carbonate units and 55-65 wt % of ester units, wherein the ester units have a molar ratio of isophthalate to terephthalate of 45:55-55:45 are often referred to as poly(carbonate-ester)s (PCE). Copolymers comprising 15-25 wt % of carbonate units and 75-85 wt % of ester units having a molar ratio of isophthalate to terephthalate from 98:2-88:12 are often referred to as poly(phthalate-carbonate)s (PPC). In a specific aspect, the aromatic carbonate units of poly(carbonate-monoarylate phthalate ester) are bisphenol A carbonate units.

An endcapping agent can be included during manufacture of the poly(carbonate-bisphenol phthalate ester) to provide end groups. Exemplary end-capping agents are exemplified by monocyclic phenols such as phenol and C₁₋₂₂ alkyl-substituted phenols such as p-cumyl-phenol, resorcinol monobenzoate, and p- and tertiary-butyl phenol, monoethers of diphenols, such as p-methoxyphenol, and alkyl-substituted phenols with branched chain alkyl substituents having 8-9 carbon atoms, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, mono-carboxylic acid chlorides such as benzoyl chloride, C₁₋₂₂ alkyl-substituted benzoyl chloride, toluoyl chloride, bromobenzoyl chloride, cinnamoyl chloride, and 4-nadimidobenzoyl chloride, polycyclic, mono-carboxylic acid chlorides such as trimellitic anhydride chloride, and naphthoyl chloride, and mono-chloroformates such as phenyl chloroformate, alkyl-substituted phenyl chloroformates, p-cumyl phenyl chloroformate, and toluene chloroformate. Combinations of different end groups can be used.

The poly(carbonate-bisphenol phthalate ester)s can have an M, of 2,000-100,000 g/mol, preferably 3,000-75,000 g/mol, more preferably 4,000-50,000 g/mol, more preferably 5,000-35,000 g/mol, and still more preferably 17,000-30,000 g/mol. Molecular weight determinations are performed using GPC using a cross linked styrene-divinyl benzene column, at a sample concentration of 1 milligram per milliliter, and as calibrated with bisphenol A polycarbonate standards. Samples are eluted at a flow rate of 1.0 ml/min with methylene chloride as the eluent.

The poly(carbonate-bisphenol phthalate ester) can be present from 40-94 wt %, 30-89 wt %, 30-84 wt %, 30-80 wt %, or 40-79 wt %, each based on the total weight of the composition.

The composition can further comprise a poly(carbonate-siloxane), also referred to in the art as a polycarbonate-polysiloxane copolymer. The polysiloxane blocks comprise repeating diorganosiloxane units as in formula (8)

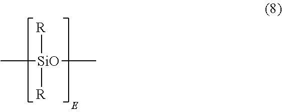

wherein each R is independently a C₁₋₁₃ monovalent organic group. For example, R can be a C₁₋₁₃ alkyl, C₁₋₁₃ alkoxy, C₂₋₁₃ alkenyl, C₂₋₁₃ alkenyloxy, C₃₋₆ cycloalkyl, C₃₋₆ cycloalkoxy, C₆₋₁₄ aryl, C₆₋₁₀ aryloxy, C₇₋₁₃ arylalkylene, C₇₋₁₃ arylalkylenoxy, C₇₋₁₃ alkylarylene, or C₇₋₁₃ alkylaryleneoxy. The foregoing groups can be fully or partially halogenated with fluorine, chlorine, bromine, or iodine, or a combination thereof. In an aspect, where a transparent poly(carbonate-siloxane) is desired, R is unsubstituted by halogen. Combinations of the foregoing R groups can be used in the same copolymer.

The value of E in formula (8) can vary widely depending on the type and relative amount of each component in the flame retardant composition, the desired properties of the composition, and like considerations. Generally, E has an average value of 2-1,000, preferably 2-500, 2-200, or 2-125, 5-80, or 10-70. In an aspect, E has an average value of 10-80 or 10-40, and in still another aspect, E has an average value of 40-80, or 40-70. Where E is of a lower value, e.g., less than 40, it can be desirable to use a relatively larger amount of the poly(carbonate-siloxane) copolymer. Conversely, where E is of a higher value, e.g., greater than 40, a relatively lower amount of the poly(carbonate-siloxane) copolymer can be used. A combination of a first and a second (or more) poly(carbonate-siloxane) copolymers can be used, wherein the average value of E of the first copolymer is less than the average value of E of the second copolymer.

In an aspect, the polysiloxane blocks are of formula (9)

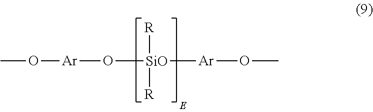

wherein E and R are as defined if formula (8); each R can be the same or different, and is as defined above; and Ar can be the same or different, and is a substituted or unsubstituted C₆₋₃₀ arylene, wherein the bonds are directly connected to an aromatic moiety. Ar groups in formula (9) can be derived from a C₆₋₃₀ dihydroxyarylene compound, for example a dihydroxyarylene compound of formula (3) or (6). Dihydroxyarylene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulfide), and 1,1-bis(4-hydroxy-t-butylphenyl) propane.

In another aspect, polysiloxane blocks are of formula (10)

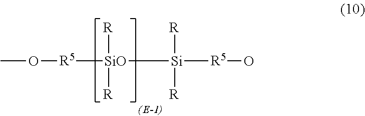

wherein R and E are as described above, and each R⁵ is independently a divalent C₁₋₃₀ organic group, and wherein the polymerized polysiloxane unit is the reaction residue of its corresponding dihydroxy compound. In a specific aspect, the polysiloxane blocks are of formula (11):

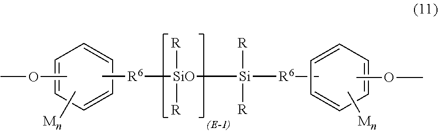

wherein R and E are as defined above. R⁶ in formula (11) is a divalent C₂₋₈ aliphatic group. Each M in formula (11) can be the same or different, and can be a halogen, cyano, nitro, C₁₋₈ alkylthio, C₁₋₈ alkyl, C₁₋₈ alkoxy, C₂₋₈ alkenyl, C₂₋₈ alkenyloxy, C₃₋₈ cycloalkyl, C₃₋₈ cycloalkoxy, C₆₋₁₀ aryl, C₆₋₁₀ aryloxy, C₇₋₁₂ aralkyl, C₇₋₁₂ aralkoxy, C₇₋₁₂ alkylaryl, or C₇₋₁₂ alkylaryloxy, wherein each n is independently 0, 1, 2, 3, or 4.

In an aspect, M is bromo or chloro, an alkyl such as methyl, ethyl, or propyl, an alkoxy such as methoxy, ethoxy, or propoxy, or an aryl such as phenyl, chlorophenyl, or tolyl; R⁶ is a dimethylene, trimethylene or tetramethylene; and R is a C₁₋₈ alkyl, haloalkyl such as trifluoropropyl, cyanoalkyl, or aryl such as phenyl, chlorophenyl or tolyl. In another aspect, R is methyl, or a combination of methyl and trifluoropropyl, or a combination of methyl and phenyl. In still another aspect, R is methyl, M is methoxy, n is one, and R⁶ is a divalent C₁₋₃ aliphatic group. Specific polysiloxane blocks are of the formula

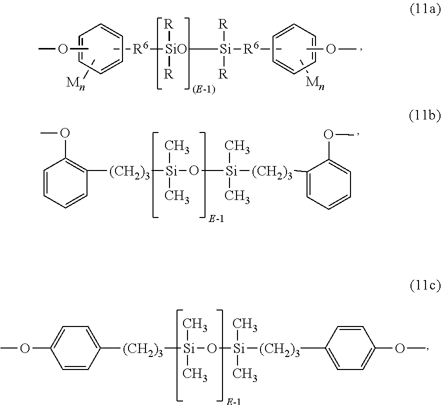

or a combination thereof, wherein E has an average value of 2-200, 2-125, 5-125, 5-100, 5-50, 20-80, or 5-20.

Blocks of formula (11) can be derived from the corresponding dihydroxy polysiloxane, which in turn can be prepared effecting a platinum-catalyzed addition between the siloxane hydride and an aliphatically unsaturated monohydric phenol such as eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. The poly(carbonate-siloxane) copolymers can then be manufactured, for example, by the synthetic procedure of European Patent Application Publication No. 0 524 731 A1 of Hoover, page 5, Preparation 2.

The poly(carbonate-siloxane) copolymers can comprise 50-99 wt % of carbonate units and 1-50 wt % siloxane units. Within this range, the poly(carbonate-siloxane) copolymer can comprise 70-98 wt %, more preferably 75-97 wt % of carbonate units and 2-30 wt %, more preferably 3-25 wt % siloxane units.

Poly(carbonate-siloxane)s can have a weight average molecular weight of 2,000-100,000 g/mol, preferably 5,000-50,000 g/mol as measured by gel permeation chromatography using a crosslinked styrene-divinyl benzene column, at a sample concentration of 1 milligram per milliliter, and as calibrated with polycarbonate standards. The poly(carbonate-siloxane)s can have a melt volume flow rate, measured at 300° C./1.2 kg, of 1-50 cubic centimeters per 10 minutes (cc/10 min), preferably 2-30 cc/10 min. Combinations of the poly(carbonate-siloxane)s of different flow properties can be used to achieve the overall desired flow property.

The poly(carbonate-siloxane)s can be present from 10-60 wt %, 10-50 wt %, 10-40 wt %, 10-30 wt %, 10-25 wt %, or 10-20 wt %, each based on the total weight of the flame retardant composition.

The poly(ester) can include units of formula (4) wherein J is an aliphatic divalent group derived from a dihydroxy compound (which includes a reactive derivative thereof), and can be, for example, a C₁₋₁₀ alkylene, a C₆₋₂₀ cycloalkylene, or a polyoxyalkylene group in which the alkylene groups contain 2 to 6 carbon atoms, preferably, 2, 3, or 4 carbon atoms; and T is a divalent group derived from a dicarboxylic acid (which includes a reactive derivative thereof), and can be, for example, a C₁₋₂₀ alkylene, a C₅₋₂₀ cycloalkylene, or a C₆₋₂₀ arylene. Copolyesters containing a combination of different T or J groups can be used.

Dicarboxylic acids (e.g., aliphatic dicarboxylic acids, alicyclic dicarboxylic acids, aromatic dicarboxylic acids, and combinations thereof) and diols (e.g., aliphatic diols, alicyclic diols, aromatic diols, and combinations thereof) can be used to prepare the poly(ester)s. Chemical equivalents of dicarboxylic acids (e.g., anhydrides, acid chlorides, acid bromides, carboxylate salts, or esters) and chemical equivalents of diols (e.g., esters, preferably C₁-C₈ esters such as acetate esters) can also be used to prepare the poly(ester)s.

Exemplary aromatic dicarboxylic acids include isophthalic acid, terephthalic acid, 1,2-di(p-carboxyphenyl)ethane, 4,4′-dicarboxydiphenyl ether, 4,4′-bisbenzoic acid, and the like, and 1,4- or 1,5-naphthalene dicarboxylic acids and the like. A combination of isophthalic acid and terephthalic acid can be used. The weight ratio of isophthalic acid to terephthalic acid may be, for example, 91:9-2:98, or 25:75-2:98. Dicarboxylic acids containing fused rings that can be used to prepare the poly(ester)s include 1,4-, 1,5-, and 2,6-naphthalenedicarboxylic acids. Exemplary cycloaliphatic dicarboxylic acids include, decahydronaphthalene dicarboxylic acids, norbornene dicarboxylic acids, bicyclooctane dicarboxylic acids, and 1,4-cyclohexanedicarboxylic acids.

Preferably the poly(ester) is a poly(alkylene terephthalate). The alkylene group of the poly(alkylene terephthalate) can comprise 2-18 carbon atoms. Exemplary alkylene groups include ethylene, 1,3-propylene, 1,4-butylene, 1,5-pentylene, 1,6-hexylene, 1,4-cyclohexylene, 1,4-cyclohexanedimethylene, or a combination thereof. For example, the alkylene group is ethylene, 1,4-butylene, or a combination thereof.

The poly(alkylene terephthalate) can be a copoly(ester) derived from terephthalic acid (or a combination of terephthalic acid and up to 10 mol % of isophthalic acid) and a mixture comprising a linear C₂-C₆ aliphatic diol, such as ethylene glycol or 1,4-butylene glycol), and a C₆-C₁₂ cycloaliphatic diol, such as 1,4-cyclohexane diol, 1,4-cyclohexanedimethanol, dimethanol decalin, dimethanol bicyclooctane, 1,10-decane diol, or a combination thereof. The ester units comprising the two or more types of diols can be present in the polymer chain as random individual units or as blocks of the same type of units. Exemplary esters include poly(1,4-cyclohexylene dimethylene co-ethylene terephthalate) wherein greater than 50 mol % of the ester groups are derived from 1,4-cyclohexanedimethanol; and poly(ethylene-co-1,4-cyclohexylenedimethylene terephthalate) wherein greater than or equal to 50 mol % of the ester groups are derived from ethylene.

The poly(alkylene terephthalate)s can include up to 10 wt %, preferably up to 5 wt % of residues of monomers other than alkylene diols and terephthalic acid. For example, the poly(alkylene terephthalate) can include the residue of isophthalic acid or units derived from an aliphatic acid, such as succinic acid, glutaric acid, adipic acid, pimelic acid, 1,4-cyclohexanedicarboxylic acid, or a combination thereof.

The poly(alkylene terephthalate) can be, poly(ethylene terephthalate), poly(butylene terephthalate), poly(cyclohexanedimethanol terephthalate), poly(propylene terephthalate), or a combination thereof. In some aspects, the poly(alkylene terephthalate) is poly(ethylene terephthalate), poly(butylene terephthalate), or a combination thereof. In certain aspects, the poly(alkylene terephthalate) comprises poly(butylene terephthalate).

The poly(alkylene terephthalate) can be a poly(1,4-butylene terephthalate) obtained by polymerizing a glycol component comprising at least 70 mol %, preferably at least 80 mol %, of tetramethylene glycol (1,4-butanediol), and an acid component comprising at least 70 mol %, preferably at least 80 mol %, of terephthalic acid or poly(ester)-forming derivatives thereof. Commercial examples of PBT include those available as VALOX 315 and VALOX 195 Resin (manufactured by SABIC).

The poly(alkylene terephthalate) can include a modified poly(butylene terephthalate), that is derived in part from poly(ethylene terephthalate) recycled PET, e.g., from used soft drink bottles. The PET-derived PBT poly(ester) (“modified PBT”) can be derived from a poly(ethylene terephthalate) component such as poly(ethylene terephthalate), a poly(ethylene terephthalate) copolymer, or a combination thereof. The modified PBT can further be derived from biomass-derived 1,4-butanediol, e.g., corn-derived 1,4-butanediol or a 1,4-butanediol derived from a cellulosic material. Unlike conventional molding compositions containing virgin PBT (PBT that is derived from 1,4-butanediol and terephthalic acid monomers), the modified PBT contains units derived from ethylene glycol and isophthalic acid. Use of modified PBT can provide a valuable way to effectively use underutilized scrap PET (from post-consumer or post-industrial streams) in PBT thermoplastic molding compositions, thereby conserving non-renewable resources and reducing the formation of greenhouse gases, e.g., carbon dioxide.

Commercial examples of modified PBT resins include those available under the trade name VALOX iQ Resin manufactured by SABIC. The modified PBT can be derived from the poly(ethylene terephthalate) component by depolymerization of the poly(ethylene terephthalate) component and polymerization of the depolymerized poly(ethylene terephthalate) component with 1,4-butanediol to provide the modified PBT.

The flame retardant composition can comprise a combination of virgin poly(alkylene terephthalate) and modified poly(alkylene terephthalate), including a combination of virgin and modified poly(1,4-butylene terephthalate), the latter obtained from recycled PET.

The poly(ester)s can be present from 10-60 wt %, 10-50 wt %, 10 to less than 35 wt %, 10-30 wt %, 10-25 wt %, 10 to less than 20 wt %, or 5-25 wt %, each based on the total weight of the flame retardant composition.

An additional polymer can be present in the flame retardant composition, with the proviso that the additional polymer is selected so as to not significantly adversely affect the desired properties of the flame retardant composition, in particular viscosity and impact resistance. An exemplary additional polymer is a bisphenol A homopolycarbonate or a poly(bisphenol A carbonate-co-isophthalate-terephthalate-resorcinol ester). Preferably any additional polymer is present in an amount of less than 20 wt % more preferably less than 10 wt %, each based on the total weight of the composition. In an aspect no additional polymer is present other than the poly(carbonate-bisphenol phthalate ester), poly(carbonate-siloxane), and poly(ester).

Generally, useful flame retardants include organophosphorous compounds that include phosphorus, bromine, chlorine, or fluorine. However, non-brominated, non-chlorinated, and non-fluorinated phosphorus-containing flame retardants are preferred for regulatory reasons. Accordingly, the flame retardant composition can be essentially free of chlorine and bromine. “Essentially free of chlorine and bromine” is defined as having a bromine or chlorine content of less than or equal to 100 parts per million by weight (ppm), less than or equal to 75 ppm, or less than or equal to 50 ppm, based on the total parts by weight of the composition. Preferably, the flame retardant composition has a combined bromine and chlorine content of less than or equal to 100 ppm, less than or equal to 75 ppm, or less than or equal to 50 ppm, based on the total parts by weight of the composition. In another aspect, the flame retardant composition can be essentially free of chlorine, bromine, and fluorine. “Essentially free of chlorine, bromine, and fluorine” is defined as having a bromine, chlorine, or fluorine content of less than or equal to 100 ppm, less than or equal to 75 ppm, or less than or equal to 50 ppm, based on the total parts by weight of the composition. Preferably, the flame retardant composition has a combined bromine, chlorine, and fluorine content of less than or equal to 100 ppm, less than or equal to 75 ppm, or less than or equal to 50 ppm, based on the total parts by weight of the composition.

The aromatic organophosphorous flame retardant can monomeric, oligomeric, or polymeric, and can include a phosphate (e.g., P(═O)(OR)₃), phosphite (e.g., P(OR)₃), phosphonate (e.g., RP(═O)(OR)₂), phosphinate (e.g., R₂P(═O)(OR)), phosphine oxide (e.g., R₃P(═O)), or phosphine (e.g., R₃P), wherein each R in the phosphorus-containing groups can be the same or different, provided that at least one R is an aromatic group. A combination of different phosphorus-containing groups can be used. The aromatic group can be directly or indirectly bonded to the phosphorus, or to an oxygen of the phosphorus-containing group (i.e., an ester).

In an aspect the aromatic organophosphorous flame retardant is a monomeric phosphate. Representative monomeric aromatic phosphates are of the formula (GO)₃P═O, wherein each G is independently an alkyl, cycloalkyl, aryl, alkylarylene, or arylalkylene group having up to 30 carbon atoms, provided that at least one G is an aromatic group. Two of the G groups can be joined together to provide a cyclic group. In some aspects G corresponds to a monomer used to form the polycarbonate, e.g., resorcinol. Exemplary phosphates include phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, and the like. A specific aromatic phosphate is one in which each G is aromatic, for example, triphenyl phosphate, tricresyl phosphate, isopropylated triphenyl phosphate, and the like.

Di- or polyfunctional aromatic organophosphorous flame retardants are also useful, for example, compounds of the formulas

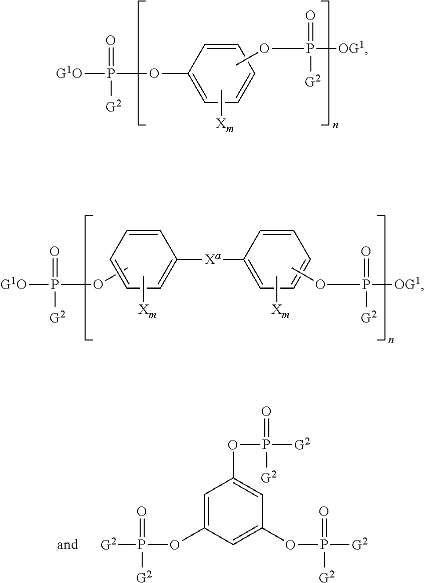

wherein each G¹ is independently a C₁₋₃₀ hydrocarbyl; each G² is independently a C₁₋₃₀ hydrocarbyl or hydrocarbyloxy; X^{a} is as defined in formula (3) or formula (4); each X is independently a bromine or chlorine; m is 0-4, and n is 1-30. In a specific aspect, X^{a} is a single bond, methylene, isopropylidene, or 3,3,5-trimethylcyclohexylidene.

Specific aromatic organophosphorous flame retardants are inclusive of acid esters of formula (12)

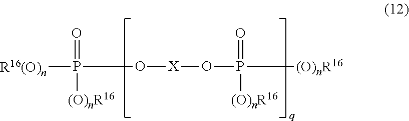

wherein each R¹⁶ is independently C₁₋₈ alkyl, C₅₋₆ cycloalkyl, C₆₋₂₀ aryl, or C₇₋₁₂ arylalkylene, each optionally substituted by C₁₋₁₂ alkyl, preferably by C₁₋₄ alkyl, and X is a mono- or poly-nuclear aromatic C₆₋₃₀ moiety or a linear or branched C₂₋₃₀ aliphatic radical, which can be OH-substituted and can contain up to 8 ether bonds, provided that at least one R¹⁶ or X is an aromatic group; each n is independently 0 or 1; and q is from 0.5-30. In some aspects each R¹⁶ is independently C₁₋₄ alkyl, naphthyl, phenyl(C₁₋₄)alkylene, aryl groups optionally substituted by C₁₋₄ alkyl; each X is a mono- or poly-nuclear aromatic C₆₋₃₀ moiety, each n is 1; and q is from 0.5-30. In some aspects each R¹⁶ is aromatic, e.g., phenyl; each X is a mono- or poly-nuclear aromatic C₆₋₃₀ moiety, including a moiety derived from formula (2); n is one; and q is from 0.8-15. In other aspects, each R¹⁶ is phenyl; X is cresyl, xylenyl, propylphenyl, or butylphenyl, one of the following divalent groups

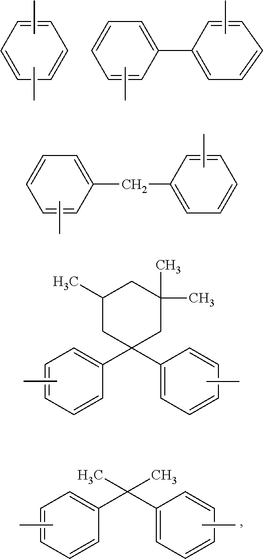

or a combination comprising one or more of the foregoing; n is 1; and q is from 1-5, or from 1-2. In some aspects at least one R¹⁶ or X corresponds to a monomer used to form the polycarbonate, e.g., bisphenol A, resorcinol, or the like. Organophosphorous flame retardants of this type include the bis(diphenyl) phosphate of hydroquinone, resorcinol bis(diphenyl phosphate) (RDP), and bisphenol A bis(diphenyl) phosphate (BPADP), and their oligomeric and polymeric counterparts.

The aromatic organophosphorous flame retardants can contain phosphorous-nitrogen bonds. Phosphazenes (13) and cyclic phosphazenes (14)

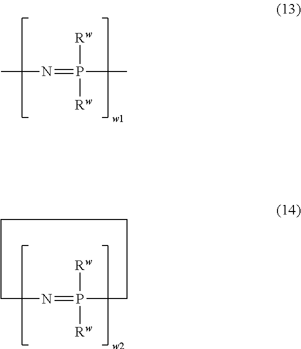

in particular can be used, wherein w1 is 3-10,000 and w2 is 3-25, preferably 3-7, and each R^{w} is independently a C₁₋₁₂ alkyl, alkenyl, alkoxy, aryl, aryloxy, or polyoxyalkylene group. In the foregoing groups at least one hydrogen atom of these groups can be substituted with a group having an N, S, O, or F atom, or an amino group. For example, each R^{w} can be a substituted or unsubstituted phenoxy, an amino, or a polyoxyalkylene group. Any given R^{w} can further be a crosslink to another phosphazene group. Exemplary crosslinks include bisphenol groups, for example bisphenol A groups. Examples include phenoxy cyclotriphosphazene, octaphenoxy cyclotetraphosphazene decaphenoxy cyclopentaphosphazene, and the like. A combination of different phosphazenes can be used. A number of phosphazenes and their synthesis are described in H. R. Allcook, “Phosphorus-Nitrogen Compounds” Academic Press (1972), and J. E. Mark et al., “Inorganic Polymers” Prentice-Hall International, Inc. (1992).

The aromatic organophosphorous flame retardant is present in an amount effective to provide 0.5-0.8 wt % of added phosphorous based on the total weight of the composition. As used herein, “added phosphorous” means phosphorus from the organophosphorous flame retardant, and excludes any phosphorous present in additives added for other purposes (e.g., tetrakis(2,4-di-tert-butylphenyl)-4,4-biphenyldiphosphonite (PEPQ) and mono zinc phosphate-2-hydrate (MZP)); and excludes any phosphorous present as a contaminant in the components used in the manufacture of the polymers of the composition, for example, i.e., the aromatic dihydroxy monomer, the aromatic dicarboxylic acid monomer, endcapping agents, and the carbonate source, for example.

The performance of the flame retardant compositions is dependent on the temperature window at which the aromatic organophosphorous flame retardant is active, and the structure of the aromatic organophosphorous flame retardant influences this temperature window. Matching the temperature window of organophosphorous activity to enhance the composition flame retardancy is preferred. In compositions comprising poly(ester-carbonate)s, the organophosphorous has a mass loss rate maximum below 420° C. as determined by thermogravimetric analysis (TGA) at a heating rate if 20° C. per minute. This improves the effectiveness of the aromatic organophosphorous flame retardant and hence in compositions comprising the preferred aromatic organophosphorous flame retardants, the loading of aromatic organophosphorous flame retardant can be lower.

The organophosphorous flame retardant can be present from 1-15 wt %, 1-10 wt %, or 5-10 wt %, each based on the total weight of the composition, in an amount effective to provide 0.5-0.8 wt % of added phosphorous based on the total weight of the flame retardant composition.

Flame retardant sulfonate salts can also be used, for example salts of C₂₋₁₆ alkyl sulfonates such as potassium perfluorobutane sulfonate (Rimar salt), potassium perfluoroctane sulfonate, and tetraethylammonium perfluorohexane sulfonate, salts of aromatic sulfonates such as sodium benzene sulfonate, sodium toluene sulfonate (NaTS), and the like, salts of aromatic sulfone sulfonates such as potassium diphenylsulfone sulfonate (KSS), and the like; salts formed by reacting for example an alkali metal or alkaline earth metal (e.g., lithium, sodium, potassium, magnesium, calcium and barium salts) and an inorganic acid complex salt, for example, an oxo-anion (e.g., alkali metal and alkaline-earth metal salts of carbonic acid, such as Na₂CO₃, K₂CO₃, MgCO₃, CaCO₃, and BaCO₃, or a fluoro-anion complex such as Li₃AlF₆, BaSiF₆, KBF₄, K₃AlF₆, KAlF₄, K₂SiF₆, or Na₃AlF₆ or the like. Rimar salt and KSS and NaTS, alone or in combination with other flame retardants, are particularly useful. When present, flame retardant sulfonate salts are generally present in amounts of 0.01-10 wt %, based on 100 parts by weight of the flame retardant composition. Rimar salt and KSS and NaTS, alone or in combination with other flame retardants, are particularly useful. The flame retardant sulfonate salts can be present in the flame retardant composition in an amount of 0.01-10 wt %, 0.01-0.1 wt %, or 0.02-0.06 wt %, or 0.03-0.05 wt %. Exemplary amounts of flame retardant sulfonate salts can be 0.01-0.6 wt %, or 0.1-0.4 wt %, or 0.25-0.35 wt %, based on the total weight of the flame retardant composition.

An anti-drip agent can be present in the flame retardant composition, for example a fibril forming or non-fibril forming fluoropolymer such as polytetrafluoroethylene (PTFE). The anti-drip agent can be encapsulated by a rigid copolymer as described above, for example styrene-acrylonitrile copolymer (SAN). PTFE encapsulated in SAN is known as TSAN. Encapsulated fluoropolymers can be made by polymerizing the encapsulating polymer in the presence of the fluoropolymer, for example an aqueous dispersion. TSAN can provide significant advantages over PTFE, in that TSAN can be more readily dispersed in the composition. TSAN can comprise 50 wt % PTFE and 50 wt % SAN, based on the total weight of the encapsulated fluoropolymer. The SAN can comprise, for example, 75 wt % styrene and 25 wt % acrylonitrile based on the total weight of the copolymer. Alternatively, the fluoropolymer can be pre-blended in some manner with a second polymer, such as for, example, an aromatic polycarbonate or SAN to form an agglomerated material for use as an anti-drip agent. Either method can be used to produce an encapsulated fluoropolymer. Anti-drip agents care generally used in amounts of 0.1-0.6 wt %, or 0.1-0.3 wt %, or 0.1-0.2 wt %, each based on the total weight of the flame retardant composition, which sums to 100 wt %.

The flame retardant composition includes a reinforcing fiber (including continuous and chopped fibers) such as asbestos, carbon fibers, glass fibers, such as E, A, C, ECR, R, S, D, or NE glasses, or the like. In addition, the glass fibers can be provided in the form of monofilament or multifilament fibers and can be used individually or in combination with other types of fiber, through, for example, co-weaving or core/sheath, side-by-side, orange-type or matrix and fibril constructions, or by other methods known to one skilled in the art of fiber manufacture. Co-woven structures include glass fiber-carbon fiber, carbon fiber-aromatic polyimide (aramid) fiber, and aromatic polyimide fiberglass fiber or the like. Preferably the reinforcing fiber is a glass fiber.

The glass fibers can be of any cross-sectional shape, for example round, square, ovoid, or irregular. The glass fibers can have an average largest diameter from 1 micrometer to 1 millimeter, or from 1-500 micrometers. The glass fibers can be supplied in the form of, for example, individual fibers, rovings, woven fibrous reinforcements, such as 0-90 degree fabrics or the like; non-woven fibrous reinforcements such as continuous strand mat, chopped strand mat, tissues, papers, felts, or the like; or three-dimensional reinforcements such as braids. The glass fibers can be present from 5-45 wt %, 5-35 wt %, 5-30 wt %, 5-25 wt %, 5-20 wt %, 5-15 wt %, or from 5-10 wt % based on the total weight of the flame retardant composition, which sums to 100 wt %.

The flame retardant compositions can include various additives ordinarily incorporated into polymer compositions of this type, with the proviso that the additive(s) are selected so as to not significantly adversely affect the desired properties of the flame retardant composition, in particular viscosity and impact resistance. Such additives can be mixed at a suitable time during the mixing of the components for forming the composition. Additives include impact modifiers, fillers, reinforcing agents different from glass fibers, antioxidants, heat stabilizers, light stabilizers, ultraviolet (UV) light stabilizers, plasticizers, lubricants, mold release agents, antistatic agents, colorants such as such as titanium dioxide, carbon black, and organic dyes, surface effect additives, radiation stabilizers, and flame retardants different from the aromatic organophosphorous flame retardant and the flame retardant sulfonate salt. A combination of additives can be used, for example a combination of an antioxidant, a heat stabilizer, mold release agent, and ultraviolet light stabilizer. In general, the additives are used in the amounts generally known to be effective. For example, the total amount of the additives (other than any impact modifier, filler, or reinforcing agents) can be 0.01-10 wt %, preferably 0.01-5 wt % based on the total weight of the flame retardant composition.

Antioxidant additives include organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. Antioxidants are generally used in amounts of 0.01-0.1 wt %, preferably 0.05-0.1 wt %, based on 100 parts by weight of the flame retardant composition.

The flame retardant compositions can be manufactured by various methods known in the art. For example, powdered poly(ester-carbonate), and other optional components are first blended, optionally with any fillers, in a high speed mixer or by hand mixing. The blend is then fed into the throat of a twin-screw extruder via a hopper. Alternatively, at least one of the components can be incorporated into the composition by feeding it directly into the extruder at the throat or downstream through a sidestuffer, or by being compounded into a masterbatch with a desired polymer and fed into the extruder. The extruder is generally operated at a temperature higher than that necessary to cause the composition to flow. The extrudate can be immediately quenched in a water bath and pelletized. The pellets so prepared can be one-fourth inch long or less as desired. Such pellets can be used for subsequent molding, shaping, or forming.

Shaped, formed, or molded articles comprising the flame retardant compositions are also provided. The flame retardant compositions can be molded into useful shaped articles by a variety of methods, such as injection molding, extrusion, rotational molding, blow molding and thermoforming. Some examples of articles include computer and business machine housings such as housings for monitors, handheld electronic device housings such as housings for cell phones, electrical connectors, and components of lighting fixtures, ornaments, home appliances, roofs, greenhouses, sun rooms, swimming pool enclosures, and the like. In addition, the flame retardant compositions can be used for electrical components, preferably a circuit breaker.

Exemplary articles include an electronic device, a scientific or medical device, an autoclavable article, a safety shield, a fire shield, wire or cable sheathing, a mold, a dish, a tray, a screen, an enclosure, glazing, packaging, a gas barrier, an anti-fog layer, or an anti-reflective layer.

The compositions can be used in component of a device comprising a lens, a device comprising a light guide, a device comprising a waveguide, a device comprising a collimator, a device comprising an optical fiber, a device comprising a lighting element, a device comprising a window, a device comprising a door, or the article is a structural component of a vehicle, a building, or an appliance, or the article is a component of a medical device, a component of a display screen, a component of an electronic device, a component of a safety device, a component of a screen, a component of conveyor, a component of a mold, a component of a dish, a component of an enclosure, a component of packaging, a component of a gas barrier, a component of an encapsulant, a component of a label, a component of a gas.

Advantageously, the flame retardant compositions have a UL 94 rating of V0 at a thickness of 0.6 millimeter. It is a further advantage that the flame retardant compositions can have a UL 94 rating of V0 at a thickness of 0.6 millimeter after aging at 70° C. for 168 hours.

This disclosure is further illustrated by the following examples, which are non-limiting.

### EXAMPLES

The materials shown in Table 1 were used.

TABLE 1

| Component | Description (Trade name) | Source |
|---|---|---|
| PPC | Poly(80 wt % BPA ester)-co-(20 wt % BPA carbonate) having a 93:7 | SABIC |
| | mixture of isophthalate and terephthalate ester groups, Mw = 27,000- | |
| | 29,000 g/mol as determined by GPC using polystyrene standards, | |
| | Tg = 174° C. | |
| PC-Si | Poly(bisphenol A-dimethylsiloxane) copolymer, produced via | SABIC |
| | interfacial polymerization, 20 wt % siloxane, average siloxane block | |
| | length = 45 units (D45), Mw = 29,000-31,000 g/mol as determined by | |
| | GPC using polystyrene standards, para-cumylphenol (PCP) end- | |
| | capped, polydispersity = 2-3 | |
| PBT | Poly(1,4-butylene terephthalate), Mw 66,000 g/mol as determined by | |
| | GPC using polystyrene standards | |
| MZP | Mono zinc phosphate-2-hydrate (quencher) | Chemische |
| | | Fabriek |
| | | ning |
| SOL-DP | Solid phosphonate ester, having the tradename FYROLFLEX Sol-DP, | ICL-IP |
| | 10.7 percent phosphorus by weight. | |
| PEPQ | Tetrakis(2,4-di-tert-butylphenyl)-4,4-biphenyldiphosphonite, CAS | Clariant |
| | 119345-01-6 | |
| GF | Bonding fiberglass | Nippon |
| | | Electric |
| | | Glass |

The samples were prepared as described below and the following test methods were used.

All powder additives were combined together with the polycarbonate powder(s), using a paint shaker, and fed through one feeder to an extruder. Extrusion for all combinations was performed on a 25 mm twin screw extruder, using a melt temperature of 270-300° C. and 300 revolutions per minute (rpm), then pelleted. The glass fibers were fed separately through the hopper on a downstream side-feeder. The pellets were dried for 3-5 hours at 90-100° C. Dried pellets were injection molded at temperatures of 280-300° C. to form specimens for most of the tests below. Thin-wall parts (0.8 mm) were molded at 290-315° C.

Heat distortion temperatures were recorded, in accordance with the ISO-75 standard with a 5.5 J hammer, using the flat side of 4 mm-thick ISO bars and a load of 1.8 MPa (A/f).

Melt volume rates were measured in accordance with the ISO-1133. The granules were dried for 3 hours at 120° C.

Vicat softening temperatures were measured on 4 mm ISO bars in accordance with the ISO-306 standard at a load of 50 N and a speed of 120° C./h (B 120).

Tensile modulus was measured according to ISO 527 on a 4 mm-thick sample.

Izod notched impact strength (INI ASTM) was determined at room temperature (23° C.) on one-eighth inch (3.18 mm) bars per ASTM D256-02.

Izod notched impact strength (INI ISO) were performed on notched 4 mm-thick ISO bars at 23° C., in accordance with the ISO-180:2000 standard with a 5.5 J hammer.

Flammability tests were performed at a sample thickness of 1.5 mm, 1.2 mm, or 0.8 mm in accordance with the UL94 standard. In some cases, a second set of 5 bars was tested to give an indication of the robustness of the rating. The ratings are described in Table 2. “FOT” is the total flame out time for all 5 bars (FOT=t1+t2). V-ratings were obtained for each set of 5 bars.

TABLE 2

| | t₁ and/or t₂ | 5-bar FOT | burning drips |
|---|---|---|---|
| V0 | <10 | <50 | No |
| V1 | <30 | <250 | No |
| V2 | <30 | <250 | Yes |
| N.R. (no rating) | >30 | >250 | |

### Examples 1-4

The formulations and properties of Examples 1-4 having 15 wt % and 30 wt % glass fibers are shown in Table 3. UL94 ratings are reported after aging the samples at 23° C. for 48 h or at 70° C. for 168 h.

TABLE 3

| Component | Unit | 1 | 2 | 3 | 4 |
|---|---|---|---|---|---|
| PC-Si | Wt % | | 15 | | 15 |
| PEPQ | Wt % | 0.06 | 0.06 | 0.06 | 0.06 |
| Sol-DP | Wt % | 6.5 | 6.5 | 6.5 | 6.5 |
| PPC | Wt % | 78.44 | 63.44 | 63.44 | 48.44 |
| GF | Wt % | 15 | 15 | 30 | 30 |
| Total | Wt % | 100 | 100 | 100 | 110 |
| Phosphorous | Wt % | 0.7 | 0.7 | 0.7 | 0.7 |

Properties

| | | | | | |
|---|---|---|---|---|---|
| MVR 300° C., 2.16 kg, 300 s | cm³/10 | 8 | 9 | 10 | 4* |
| | min | | | | |
| HDT-1.8 MPa-Flat | ° C. | 133 | 127 | 129 | 133 |
| VICAT-B/120 | ° C. | 141 | 134 | 137 | 139 |
| Tensile Modulus | MPa | 6236 | 6071 | 10929 | 9534 |
| INI ISO, 23° C. | kJ/m² | 6 | 10 | 8 | 12 |
| INI ASTM 23° C. | J/m | 49 | 88 | 52 | 85 |
| UL94, 1.5 mm, 23° C., 48 h | | V0 | V0 | V0 | V0 |
| Σ t1 | | 4.5 | 4.6 | 4.7 | 4.7 |
| Σ t2 | | 4.5 | 4.6 | 4.9 | 4.7 |
| Σ (t1 + t2) | | 9 | 9.2 | 9.6 | 9.4 |
| UL94, 1.5 mm, 70° C., 168 h | | V0 | V0 | V0 | V0 |
| Σ t1 | | 4.2 | 5.8 | 6.2 | 5.3 |
| Σ t2 | | 5.2 | 5.4 | 5.7 | 4.3 |
| Σ (t1 + t2) | | 9.4 | 11.2 | 11.9 | 9.6 |
| UL94, 1.2 mm 23° C., 48 h | | V0 | V0 | V0 | V0 |
| Σ t1 | | 4.2 | 4.3 | 4.6 | 5.2 |
| Σ t2 | | 4.7 | 4.8 | 6 | 5.1 |
| Σ (t1 + t2) | | 8.9 | 9.1 | 10.6 | 10.3 |
| UL94, 1.2 mm 70° C., 168 h | | V0 | V0 | V0 | V0 |
| Σ t1 | | 3.5 | 5 | 5.6 | 6.8 |
| Σ t2 | | 4.1 | 5.7 | 5.7 | 6.3 |
| Σ (t1 + t2) | | 7.6 | 10.7 | 11.3 | 13.1 |
| UL94, 0.8 mm 23° C., 48 h | | V0 | V0 | V0 | V0 |
| Σ t1 | | 4.6 | 4.5 | 4.2 | 4.8 |
| Σ t2 | | 4.8 | 5.2 | 5.8 | 5 |
| Σ (t1 + t2) | | 9.4 | 9.7 | 10 | 9.8 |
| UL94, 0.8 mm, 70° C., 168 h | | V0 | V0 | V0 | V0 |
| Σ t1 | | 4.5 | 3.9 | 4 | 4.1 |
| Σ t2 | | 4.6 | 5 | 4 | 4.6 |
| Σ (t1 + t2) | | 9.1 | 8.9 | 8 | 8.7 |

Examples 1-2 show that for poly(ester-carbonate) compositions (i.e., PPC) and poly(ester-carbonate)/poly(carbonate-siloxane) compositions (i.e., mixtures of PPC and PS-Si) having 15 wt % GF, that a UL94 rating of V0 was obtained for samples having a thickness of 1.5 mm, 1.2 mm, 1.0 mm, and 0.8 mm. As shown by Examples 3-4, increasing the loading of GF from 15 wt %-30 wt % did not adversely affect the UL94 rating. (Compare Example 1 with Example 3 and Example 2 with Example 4.)

### Examples 5-10

The formulations and properties of Examples 5-10 having 15 wt % glass fibers are shown in Table 4. UL94 ratings are reported after aging the samples at 23° C. for 48 h or at 70° C. for 168 h.

TABLE 4

| Component | Unit | 5 | 6 | 7 | 8* | 9 | 10 |
|---|---|---|---|---|---|---|---|
| PC-Si | wt % | | | | | 15 | 15 |
| PEPQ | wt % | 0.06 | 0.06 | 0.06 | 0.06 | 0.06 | 0.06 |
| PBT | wt % | | 15 | 25 | 35 | 15 | 25 |
| Sol-DP | wt % | 6.5 | 6.5 | 6.5 | 6.5 | 6.5 | 6.5 |
| PPC | wt % | 78.44 | 63.39 | 53.39 | 53.39 | 48.39 | 38.39 |
| MZP | wt % | | 0.05 | 0.05 | 0.05 | 0.05 | 0.05 |
| GF | wt % | 15 | 15 | 15 | 15 | 15 | 15 |
| Total | wt % | 100 | 100 | 100 | 110 | 100 | 100 |
| Phosphorous | wt % | 0.7 | 0.7 | 0.7 | 0.7 | 0.7 | 0.7 |
| MVR, 300° C., 2.16 kg, 300 s | cm³/10 min | 8 | 37 | 49 | 78 | 22 | 35 |
| HDT, 1.8 MPa | ° C. | 133 | 121 | 119 | 123 | 114 | 106 |
| VICAT, B/120 | ° C. | 141 | 132 | 133 | 139 | 123 | 119 |
| Tensile Modulus | MPa | 6236 | 5581 | 6964 | 6817 | 6411 | 6192 |
| INI ISO | kJ/m² | 6 | 5 | 6 | 6 | 10 | 9 |
| INI ASTM | J/m | 49 | 37 | 52 | 50 | 90 | 94 |
| UL94, 1.5 mm, 23° C., 48 h | | V0 | V0 | V0 | V2 | V0 | V0 |
| Σ t1 | | 4.5 | 4.5 | 4.7 | 5 | 4.5 | 4.7 |
| Σ t2 | | 4.5 | 4.7 | 5.1 | 12.8 | 4.6 | 6.5 |
| Σ (t1 + t2) | | 9 | 9.2 | 9.8 | 17.8 | 9.1 | 11.2 |
| Flaming Drips | # | | | | 2 | | |
| UL94, 1.5 mm, 70° C., 168 h | | V0 | V0 | V0 | V2 | V0 | V0 |
| Σ t1 | | 4.2 | 4.5 | 7.8 | 7.8 | 4.5 | 4.7 |
| Σ t2 | | 5.2 | 5.2 | 5.5 | 20 | 5.2 | 8.1 |
| Σ (t1 + t2) | | 9.4 | 9.7 | 13.3 | 27.8 | 9.7 | 12.8 |
| Flaming Drips | # | | | | 2 | | |
| UL94, 1.2 mm, 23° C., 48 h | | V0 | V0 | V0 | V2 | V0 | V0 |
| Σ t1 | | 4.2 | 4.4 | 5 | 6.8 | 4.6 | 5.3 |
| Σ t2 | | 4.7 | 5.2 | 12.4 | 10.2 | 5.7 | 13.2 |
| Σ (t1 + t2) | | 8.9 | 9.6 | 17.4 | 17 | 10.3 | 18.5 |
| Flaming Drips | # | | | | 5 | | |
| UL94, 1.2 mm, 70° C., 168 h | | V0 | V0 | V0 | V2 | V0 | V0 |
| Σ t1 | | 3.5 | 5 | 4.9 | 9.2 | 7.3 | 7.2 |
| Σ t2 | | 4.1 | 4.7 | 6.6 | 23.1 | 6.6 | 9.9 |
| Σ (t1 + t2) | | 7.6 | 9.7 | 11.5 | 32.3 | 13.9 | 17.1 |
| Flaming Drips | # | | | | 1 | | |
| UL94, 0.8 mm, 23° C., 48 h | | V0 | V0 | V2 | | V0 | V2 |
| Σ t1 | | 4.6 | 4.2 | 5.1 | | 4.3 | 5.6 |
| Σ t2 | | 4.8 | 5.6 | 10.7 | | 5.1 | 14.3 |
| Σ (t1 + t2) | | 9.4 | 9.8 | 15 8 | | 9.4 | 19.9 |
| Flaming Drips | # | | | 3 | | | 4 |
| UL94, 0.8 mm, 70° C., 168 h | | V0 | V2 | V2 | | V0 | V2 |
| Σ t1 | | 4.5 | 3.6 | 4.4 | | 3.8 | 7.5 |
| Σ t2 | | 4.6 | 11.8 | 1 | | 4.9 | 14.7 |
| Σ (t1 + t2) | | 9.1 | 15.4 | 5.4 | | 8.7 | 22.2 |
| Flaming Drips | # | | 1 | 5 | | | 3 |

*Comparative Examples

For poly(ester-carbonate)/poly(ester) compositions (i.e., mixtures of PPC and PBT) having 15 wt % GF, a UL94 rating of V0 was obtained at a sample thickness of 1.5 mm, 1.2 mm, and 0.8 mm for 15 wt % and 25 wt % PBT (Examples 6-7). As shown in Comparative Example 8, 35 wt % PBT resulted in a diminished UL94 rating (i.e., V2) at 1.5 mm. Poly(ester-carbonate)/poly(ester)/poly(carbonate-siloxane) compositions (mixtures of PPC, PC-Si, and PBT) having 15 wt GF resulted in a UL94 rating of V0 at 1.5 and 1.2 mm (Example 9 and Comparative Example 10); however at 0.8 mm, Comparative Example 10 had a diminished UL94 rating, whereas Example 9 resulted in a UL94 rating of V0 at 0.8 mm. It follows that at 15 at GF loading, for mixtures of PPC and PBT, the wt % a of PBT should not exceed 35 wt % a to achieve a UL94 rating of V0 at 0.8 mm and for mixtures of PPC, PBT, and PC-Si, the 15% of PBT should not exceed 25 wt % to achieve a UL94 rating of V0 at 0.8 mm.

### Examples 11-14

The formulations and properties of Examples 11-14 having 30 wt % glass fibers are shown in Table 5. UL94 ratings are reported after aging the samples at 23° C. for 48 hours (h) or at 70° C. for 168 h.

TABLE 5

| Item Description | Unit | 11 | 12 | 13* | 14 |
|---|---|---|---|---|---|
| PC-Si | Wt % | | | | 15 |
| PEPQ | Wt % | 0.06 | 0.06 | 0.06 | 0.06 |
| PBT | Wt % | | 12 | 20 | 15 |
| Sol-DP | Wt % | 6.5 | 6.5 | 6.5 | 6.5 |
| PPC | Wt % | 63.44 | 51.39 | 43.39 | 33.39 |
| MZP | Wt % | | 0.05 | 0.05 | 0.05 |
| GF | Wt % | 30 | 30 | 30 | 30 |
| Total | Wt % | 100 | 100 | 100 | 110 |
| Phosphorous | Wt % | 0.7 | 0.7 | 0.7 | 0.7 |
| MVR, 300° C., 2.16 kg, 300 s | cm³/10 min | 10 | 15 | 25 | 20 |
| HDT, 1.8 MPa-Flat | ° C. | 129 | 104 | 107 | 97 |
| VICAT-B/120 | ° C. | 137 | 117 | 122 | 116 |
| Tensile Modulus | MPa | 10929 | 10700 | 10717 | 9243 |
| INI ISO | kJ/m² | 8 | 9 | 9 | 14 |
| INI ASTM | J/m | 52 | 78 | 89 | 143 |
| UL94, 1.5 mm, 23° C., 48 h | | V0 | V0 | V0 | V0 |
| Σ t1 | | 4.7 | 4.8 | 4.9 | 4.6 |
| Σ t2 | | 4.9 | 4.8 | 7.2 | 5.3 |
| Σ (t1 + t2) | | 9.6 | 9.6 | 12.1 | 9.9 |
| Flaming Drips | # | | | | |
| UL94, 1.5 mm, 70° C., 168 h | | V0 | V0 | V0 | V0 |
| Σ t1 | | 6.2 | 5.7 | 6.4 | 5.8 |
| Σ t2 | | 5.7 | 6.6 | 6.9 | 7.2 |
| Σ (t1 + t2) | | 11.9 | 12.3 | 13.3 | 13 |
| Flaming Drips | # | | | | |
| UL94, 1.2 mm, 23° C., 48 h | | V0 | V0 | V2 | V0 |
| Σ t1 | | 4.6 | 4.7 | 7 | 5.8 |
| Σ t2 | | 6 | 7.2 | 11.8 | 11.5 |
| Σ (t1 + t2) | | 10.6 | 11.9 | 18.8 | 17.3 |
| Flaming Drips | # | | | 1 | |
| UL94, 1.2 mm, 70° C., 168 h | | V0 | V0 | V0 | V0 |
| Σ t1 | | 5.6 | 6.8 | 6.8 | 6.4 |
| Σ t2 | | 5.7 | 6.3 | 9.9 | 7.5 |
| Σ (t1 + t2) | | 11.3 | 13.1 | 16.7 | 13.9 |
| Flaming Drips | # | | | | |
| UL94, 0.8 mm, 23° C., 48 h | | V0 | V0 | V2 | V0 |
| Σ t1 | | 4.2 | 5.5 | 9.5 | 6.3 |
| Σ t2 | | 5.8 | 6.8 | 12.8 | 12.1 |
| Σ (t1 + t2) | | 10 | 12.3 | 22.3 | 18.4 |
| Flaming Drips | # | | | 3 | |
| UL94, 0.8 mm, 70° C., 168 h | | V0 | V0 | V2 | V0 |
| Σ t1 | | 4 | 4.5 | 10.5 | 6.3 |
| Σ t2 | | 4 | 4.9 | 8.5 | 9.2 |
| Σ (t1 + t2) | | 8 | 9.4 | 19 | 15.5 |
| Flaming Drips | # | | | 1 | |

*Comparative Examples

At 30 wt % GF loading, Example 11 shows that for poly(ester-carbonate) compositions a UL94 rating of V0 was obtained at sample thicknesses of 1.5 mm, 1.2 mm, and 0.8 mm. For poly(ester-carbonate)/poly(ester) compositions (i.e., mixtures of PPC and PBT) having 30 wt % GF, a UL94 rating of V0 was obtained at 1.5 mm, for both 12 wt % and 20 wt % PBT (Example 12 and Comparative Example 13). However, at 0.8 mm, the UL94 rating deteriorated for Comparative Example 13. Mixtures of PPC, PC-Si, and PBT, wherein the loading of PBT was 15 wt %, a UL94 rating of V0 was achieved at 0.8 mm. Therefore, at 30 wt % GF loading, the amount of PBT in either a PPC/PBT mixture or a PPC/PBT/PC-Si mixture should be no greater than 20 wt % for desirable flame retardant performance at 0.8 mm.

This disclosure further encompasses the following aspects.

Aspect 1: A flame retardant composition comprising: 40-94 wt % of a poly(carbonate-bisphenol phthalate ester) comprising aromatic carbonate units and bisphenol phthalate ester units, and optionally, 10-60 wt %, preferably 10-50 wt % of a poly(carbonate-siloxane); 1-15 wt % of an organophosphorous flame retardant, present in an amount effective to provide 0.5-0.8 wt % of added phosphorous; 5-45 wt % of glass fibers; optionally, 0.01-10 wt % of a flame retardant sulfonate salt; optionally, 0.1-0.6 wt % of an anti-drip agent; and optionally, 0.01-10 wt %, preferably 0.01-5 wt % of an additive composition wherein the amount of the poly(carbonate-bisphenol phthalate ester), the organophosphorous flame retardant, the glass fibers, and the optional components total 100 wt %; wherein a molded sample of the flame retardant composition has a UL 94 rating of V0 at a thickness of 1.2 millimeter, preferably a UL 94 rating of V0 at a thickness 0.8 millimeter.

Aspect 2: The flame retardant composition of aspect 1, wherein the poly(carbonate-bisphenol phthalate ester) has the formula

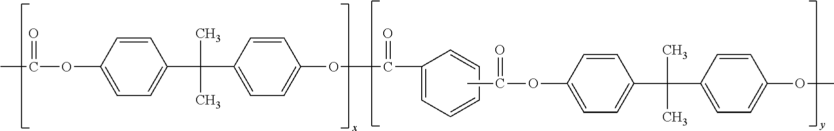

wherein

the weight ratio of carbonate units x to ester units y is 10:90-45:55, and

the ester units have a molar ratio of isophthalate to terephthalate from 98:2-88:12.

Aspect 3: The composition of aspect 1, wherein the organophosphorous flame retardant is monomeric, oligomeric, or polymeric, and is an aromatic phosphate, an aromatic phosphinate, an aromatic phosphite, an aromatic phosphonate, an aromatic phosphine oxide, or a combination thereof.

Aspect 4: The composition of aspect 1, wherein the organophosphorous flame retardant is of the formula

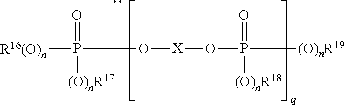

wherein

R¹⁶, R¹⁷, R¹⁸ and R¹⁹ are each independently C₁₋₈ alkyl, C₅₋₆ cycloalkyl, C₆₋₂₀ aryl, or C₇₋₁₂ arylalkylene, each optionally substituted by C₁₋₁₂ alkyl, and

X is a mono- or poly-nuclear aromatic C₆₋₃₀ moiety or a linear or branched C₂₋₃₀ aliphatic radical, each of which is optionally OH-substituted and optionally contain up to 8 ether bonds, provided that at least one of R¹⁶, R¹⁷, R¹⁸, R¹⁹, and X is aromatic,

n is each independently 0 or 1, and

q is from 0.5 to 30, and

preferably wherein

each of R¹⁶, R¹⁷, R¹⁸, and R¹⁹ is phenyl,

X is of the formula

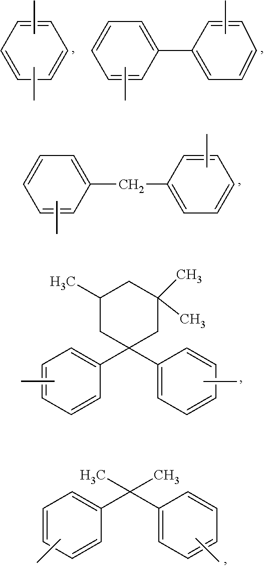

or a combination thereof,

each n is 1, and

q is 1 to 5.

Aspect 5: The composition of aspect 1, wherein the organophosphorous flame retardant is of the formula

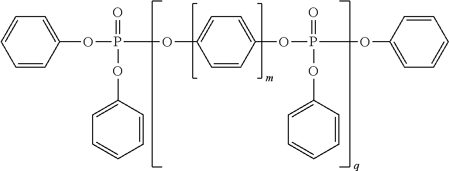

wherein m is 1 or 2, and q is 1 to 5.

Aspect 6: The flame retardant composition of aspect 1, wherein the anti-drip agent is present and is polytetrafluoroethylene, polytetrafluoroethylene encapsulated styrene-acrylonitrile copolymer, or a combination thereof.

Aspect 7: The flame retardant composition of aspect 1, wherein the flame retardant sulfonate salt is present and is potassium perfluorobutane sulfonate, potassium diphenylsulfone sulfonate, or a combination thereof.

Aspect 8: The flame retardant composition of aspect 1, wherein the organophosphorous flame retardant has a mass loss maximum below 420° C. as determined by thermogravimetric analysis at a heating rate if 20° C. per minute.

Aspect 9: The flame retardant composition of aspect 1, wherein the poly(carbonate-siloxane) is present in an amount effective to provide 2-6 wt % siloxane, preferably 2-4 wt % of dimethyl siloxane.

Aspect 10: The flame retardant composition of aspect 1 comprising 40-79 wt % of the poly(carbonate-bisphenol phthalate ester), 10-35 wt % of the poly(carbonate-siloxane), 1-15 wt % of an organophosphorous flame retardant, present in an amount effective to provide 0.5-0.8 wt % of added phosphorous; and 10-30 wt % of the glass fibers.

Aspect 11: A flame retardant composition comprising: 30-89 wt % of a poly(carbonate-bisphenol phthalate ester) comprising aromatic carbonate units and bisphenol phthalate ester units, and 5-25 wt % of a poly(ester), optionally, 5-25 wt %, preferably 5-20 wt % (polycarbonate-siloxane); 1-15 wt % of an organophosphorous flame retardant, present in an amount effective to provide 0.5-0.8 wt % of added phosphorous; 5-45 wt % of glass fibers; optionally, 0.01-10 wt % of a flame retardant sulfonate salt; optionally, 0.1-0.6 wt % of an anti-drip agent; and optionally, 0.01-10 wt %, preferably 0.01-5 wt % of an additive composition wherein the amount of the poly(carbonate-bisphenol phthalate ester), the poly(ester), the organophosphorous flame retardant, the glass fibers, and the optional components total 100 wt %; wherein a molded sample of the flame retardant composition has a UL 94 rating of V0 at a thickness of 1.2 millimeter, preferably a UL 94 rating of V0 at a thickness 0.8 millimeter.

Aspect 12: The flame retardant composition of aspect 11, wherein the poly(carbonate-bisphenol phthalate ester) has the formula

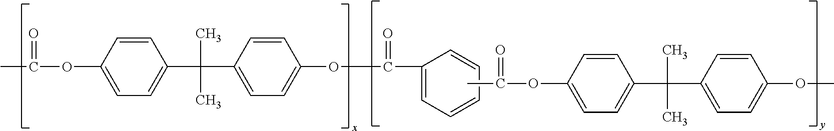

wherein the weight ratio of carbonate units x to ester units y is 10:90-45:55, and the ester units have a molar ratio of isophthalate to terephthalate from 98:2-88:12.

Aspect 13: The composition of aspect 11, wherein the organophosphorous flame retardant is monomeric, oligomeric, or polymeric, and is an aromatic phosphate, an aromatic phosphinate, an aromatic phosphite, an aromatic phosphonate, an aromatic phosphine oxide, or a combination thereof.

Aspect 14: The composition of aspect 11, wherein the organophosphorous flame retardant is of the formula

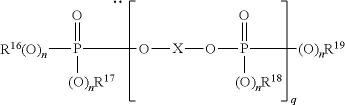

wherein

R¹⁶, R¹⁷, R¹⁸ and R¹⁹ are each independently C₁₋₈ alkyl, C₅₋₆ cycloalkyl, C₆₋₂₀ aryl, or C₇₋₁₂ arylalkylene, each optionally substituted by C₁₋₁₂ alkyl, and

X is a mono- or poly-nuclear aromatic C₆₋₃₀ moiety or a linear or branched C₂₋₃₀ aliphatic radical, each of which is optionally OH-substituted and optionally contain up to 8 ether bonds, provided that at least one of R¹⁶, R¹⁷, R¹⁸, R¹⁹, and X is aromatic,

n is each independently 0 or 1, and

q is from 0.5 to 30, and

preferably wherein

each of R¹⁶, R¹⁷, R¹⁸, and R¹⁹ is phenyl,

X is of the formula

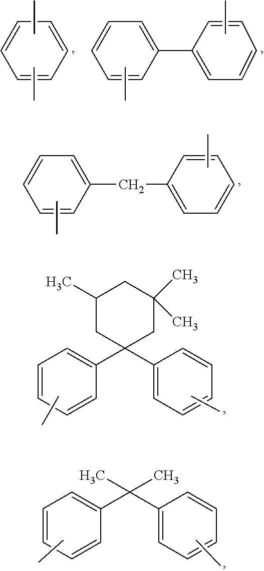

or a combination thereof,

each n is 1, and

q is 1 to 5.

Aspect 15: The composition of any aspect 11, wherein the organophosphorous flame retardant is of the formula

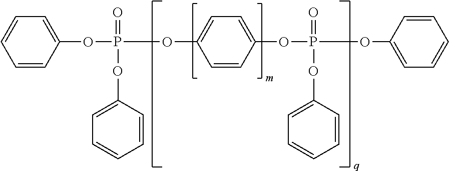

wherein m is 1 or 2, and q is 1 to 5.

Aspect 16: The flame retardant composition of aspect 11, wherein the anti-drip agent is present and is polytetrafluoroethylene, polytetrafluoroethylene encapsulated styrene-acrylonitrile copolymer, or a combination thereof.

Aspect 17: The flame retardant composition of aspect 11, wherein the flame retardant sulfonate salt is present and is potassium perfluorobutane sulfonate, potassium diphenylsulfone sulfonate, or a combination thereof.

Aspect 18: The flame retardant composition of aspect 11, wherein the organophosphorous flame retardant has a mass loss maximum below 420° C. as determined by thermogravimetric analysis at a heating rate if 20° C. per minute.

Aspect 19: The flame retardant composition of aspect 11, wherein the poly(carbonate-siloxane) is present in an amount effective to provide 2-6 wt % siloxane, preferably 2-4 wt % of dimethyl siloxane.

Aspect 20: The flame retardant composition of aspect 11, wherein the poly(ester) is a poly(alkylene terephthalate), preferably a poly(ethylene terephthalate), poly(butylene terephthalate), poly(ethylene naphthanoate), poly(butylene naphthanoate), poly(cyclohexanedimethanol terephthalate), poly(propylene terephthalate), or a combination thereof, most preferably poly(butylene terephthalate).

Aspect 21: The flame retardant composition of aspect 11, comprising 30-84 wt % of the poly(carbonate-bisphenol phthalate ester), 10 to less than 20 wt % of the poly(alkylene terephthalate); 1-15 wt % of an organophosphorous flame retardant, present in an amount effective to provide 0.5-0.8 wt % of added phosphorous; and 5-45 wt % of glass fibers.

Aspect 22: The flame retardant composition of aspect 11, comprising 30-84 wt % of the poly(carbonate-bisphenol phthalate ester), 10 to less than 35 wt % of the poly(alkylene terephthalate); 1-15 wt % of an organophosphorous flame retardant, present in an amount effective to provide 0.5-0.8 wt % of added phosphorous; and 5-20 wt % of glass fibers.

Aspect 23: An article comprising the flame retardant composition of aspect 1 or 11.

Aspect 24: The article of aspect 23 wherein the article is an electrical component, preferably a circuit breaker.

Aspect 25: A method for forming the article according to aspect 23, comprising molding, casting, or extruding the article.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5 wt %-20 wt %”, is inclusive of the endpoints and all intermediate values of the ranges of “5 wt %-25 wt %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments,” “an embodiment,” and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed.

Unless specified to the contrary herein, all test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

The term “alkyl” means a branched or straight chain, unsaturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo groups (e.g., bromo and fluoro), or only chloro groups can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl)a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A flame retardant composition comprising:
40-94 wt % of a poly(carbonate-bisphenol phthalate ester) comprising aromatic carbonate units and bisphenol phthalate ester units, and
optionally, 10-60 wt % % of a poly(carbonate-siloxane);
1-15 wt % of an organophosphorous flame retardant, present in an amount effective to provide 0.5-0.8 wt % of added phosphorous;
5-45 wt % of glass fibers;
optionally, 0.01-10 wt % of a flame retardant sulfonate salt;
optionally, 0.1-0.6 wt % of an anti-drip agent; and
optionally, 0.01-10 wt % of an additive composition
wherein the amount of the poly(carbonate-bisphenol phthalate ester), the organophosphorous flame retardant, the glass fibers, and the optional components total 100 wt %;
wherein a molded sample of the flame retardant composition has a UL 94 rating of V0 at a thickness of 1.2 millimeter.

2. The flame retardant composition of claim 1, wherein the poly(carbonate-bisphenol phthalate ester) has the formula 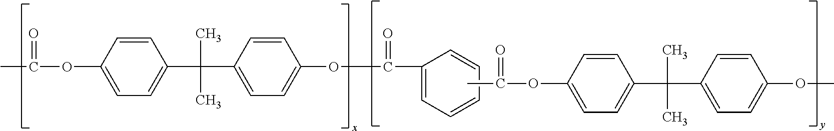
wherein
the weight ratio of carbonate units x to ester units y is 10:90-45:55, and
the ester units have a molar ratio of isophthalate to terephthalate from 98:2-88:12.

3. The composition of claim 1, wherein the organophosphorous flame retardant is monomeric, oligomeric, or polymeric, and is an aromatic phosphate, an aromatic phosphinate, an aromatic phosphite, an aromatic phosphonate, an aromatic phosphine oxide, or a combination thereof.

4. (canceled)

5. (canceled)

6. The flame retardant composition of claim 1, wherein the anti-drip agent is present and is polytetrafluoroethylene, polytetrafluoroethylene encapsulated styrene-acrylonitrile copolymer, or a combination thereof.

7. (canceled)

8. The flame retardant composition of claim 1, wherein the organophosphorous flame retardant has a mass loss maximum below 420° C. as determined by thermogravimetric analysis at a heating rate if 20° C. per minute.

9. The flame retardant composition of claim 1, wherein the poly(carbonate-siloxane) is present in an amount effective to provide 2-6 wt % siloxane.

10. The flame retardant composition of claim 1 comprising
40-79 wt % of the poly(carbonate-bisphenol phthalate ester),
10-35 wt % of the poly(carbonate-siloxane),
1-15 wt % of an organophosphorous flame retardant, present in an amount effective to provide 0.5-0.8 wt % of added phosphorous; and
10-30 wt % of the glass fibers.

11. A flame retardant composition comprising:
30-89 wt % of a poly(carbonate-bisphenol phthalate ester) comprising aromatic carbonate units and bisphenol phthalate ester units, and
5-25 wt % of a poly(ester),
optionally, 5-25 wt % (polycarbonate-siloxane);
1-15 wt % of an organophosphorous flame retardant, present in an amount effective to provide 0.5-0.8 wt % of added phosphorous;
5-45 wt % of glass fibers;
optionally, 0.01-10 wt % of a flame retardant sulfonate salt;
optionally, 0.1-0.6 wt % of an anti-drip agent; and
optionally, 0.01-10 wt % of an additive composition
wherein the amount of the poly(carbonate-bisphenol phthalate ester), the poly(ester), the organophosphorous flame retardant, the glass fibers, and the optional components total 100 wt %;
wherein a molded sample of the flame retardant composition has a UL 94 rating of V0 at a thickness of 1.2 millimeter.

12. The flame retardant composition of claim 11, wherein the poly(carbonate-bisphenol phthalate ester) has the formula 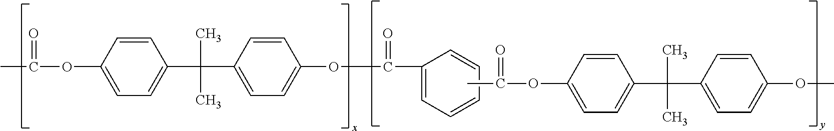
wherein
the weight ratio of carbonate units x to ester units y is 10:90-45:55, and
the ester units have a molar ratio of isophthalate to terephthalate from 98:2-88:12.

13. The composition of claim 11, wherein the organophosphorous flame retardant is monomeric, oligomeric, or polymeric, and is an aromatic phosphate, an aromatic phosphinate, an aromatic phosphite, an aromatic phosphonate, an aromatic phosphine oxide, or a combination thereof.

14. (canceled)

15. (canceled)

16. The flame retardant composition of claim 11, wherein the anti-drip agent is present and is polytetrafluoroethylene, polytetrafluoroethylene encapsulated styrene-acrylonitrile copolymer, or a combination thereof.

17. (canceled)

18. The flame retardant composition of claim 11, wherein the organophosphorous flame retardant has a mass loss maximum below 420° C. as determined by thermogravimetric analysis at a heating rate if 20° C. per minute.

19. The flame retardant composition of claim 11, wherein the poly(carbonate-siloxane) is present in an amount effective to provide 2-6 wt % siloxane.

20. The flame retardant composition of claim 11, wherein the poly(ester) is a poly(alkylene terephthalate), preferably a poly(ethylene terephthalate), poly(butylene terephthalate), poly(ethylene naphthanoate), poly(butylene naphthanoate), poly(cyclohexanedimethanol terephthalate), poly(propylene terephthalate), or a combination thereof, most preferably poly(butylene terephthalate).

21. The flame retardant composition of claim 11, comprising
30-84 wt % of the poly(carbonate-bisphenol phthalate ester),
10 to less than 20 wt % of the poly(alkylene terephthalate);
1-15 wt % of an organophosphorous flame retardant, present in an amount effective to provide 0.5-0.8 wt % of added phosphorous; and
5-45 wt % of glass fibers.

22. The flame retardant composition of claim 11, comprising
30-84 wt % of the poly(carbonate-bisphenol phthalate ester),
10 to less than 35 wt % of the poly(alkylene terephthalate);
1-15 wt % of an organophosphorous flame retardant, present in an amount effective to provide 0.5-0.8 wt % of added phosphorous; and
5-20 wt % of glass fibers.

23. An article comprising the flame retardant composition of claim 1.

24. (canceled)

25. A method for forming the article according to claim 23, comprising molding, casting, or extruding the article.

26. An article comprising the flame retardant composition of claim 11.

27. A method for forming the article according to claim 26, comprising molding, casting, or extruding the article
